(19) United States
(12) Patent Application Publication
(10) Pub. No.: US 2013/0188466 A1
(43) Pub. Date: Jul. 25, 2013

(54) OPTICAL PICKUP APPARATUS

(71) Applicant: SANYO ELECTRIC CO., LTD., Osaka (JP)

(72) Inventors: Chiaki ASAKAWA, Ora-gun (JP); Kiyotaka EIZUMI, Ora-gun (JP)

(73) Assignee: SANYO ELECTRIC CO., LTD., Osaka (JP)

(21) Appl. No.: 13/790,686

(22) Filed: Mar. 8, 2013

Related U.S. Application Data
(63) Continuation of application No. PCT/JP2011/070201, filed on Sep. 6, 2011.

(30) Foreign Application Priority Data
Sep. 8, 2010 (JP) 2010-201215

(51) Int. Cl. G11B 7/1395

(52) U.S. Cl. CPC G11B 7/1395
USPC 369/110.02

(57) ABSTRACT

An optical-pickup apparatus includes: a laser-light-source unit to emit a laser beam having a first or second wavelength selectively; an objective lens; a photodetector; a light-splitting unit to split first and second laser beams respectively emitted from the laser-light-source unit and an optical-recording medium according to a wavelength and polarization direction, and guide the first and second laser beams to the lens and photodetector, respectively; and a quarter-wave plate arranged between the light-splitting unit and lens to convert the laser beams having the first and second wavelengths incident thereon through the light-splitting unit, from linearly-polarized light to circularly-polarized light and from linearly-polarized light to elliptically-polarized light, respectively, the laser beam having the second wavelength being incident, as first linearly-polarized light, on the light-splitting unit, and the light-splitting unit performing phase shift for the laser beam having the second wavelength incident thereon through the quarter-wave plate to reduce a first-linearly-polarized-light component.

### CROSS-REFERENCE TO RELATED APPLICATIONS

The present application is a continuation under 35. U.S.C. §120 of PCT/JP2011/070201, filed Sep. 6, 2011, which is incorporated herein by reference and which claimed priority to Japanese Patent Application No. 2010-201215 filed Sep. 8, 2010. The present application likewise claims priority under 35 U.S.C. §119 to Japanese Patent Application No. 2010-201215 filed Sep. 8, 2010, the entire content of which is also incorporated herein by reference.

### BACKGROUND OF THE INVENTION

1. Field of the Invention

The present invention relates to an optical pickup apparatus.

2. Description of the Related Art

Recently, some optical pickup apparatuses that perform reading/writing of signals with respect to optical discs (optical recording media) are capable of supporting a plurality of optical discs of different standards.

For example, Patent Literature 1 (Japanese Patent Application Laid-open Publication No. 2003-91863) discloses an optical pickup apparatus (optical head device) that supports an optical disc of DVD (Digital Versatile Disc) (registered trademark) standard using a red beam having a wavelength of 650 nm band and an optical disc of CD (Compact Disc) (trademark) standard using an infrared light having a wavelength of 780 nm band, and allows commonality of a photodetector that detects reflected light. Further, for example, Patent Literature 2 (Japanese Patent Application Laid-open Publication No. 2001-126304) discloses an optical pickup apparatus capable of supporting optical discs of DVD standard and CD standard by using a two-wavelength multi-laser light source in which a laser light source for a laser beam having a wavelength of 650 nm band and a laser light source for a laser beam having a wavelength of 780 nm band are provided in the same package.

As such, commonality of a photodetector, a laser light source and the like is enabled, so as to reduce the number of components, thereby being able to realize cost reduction, size reduction, facilitation of manufacturing and the like of the optical pickup apparatus.

An example of a configuration of an optical pickup apparatus is illustrated here in FIG. 5 which supports the optical discs of both DVD standard and CD standard and allows communality of a photodetector, a laser light source and the like. In FIG. 5, a laser light source unit 1 is configured as a two-wavelength multi-laser light source, for example, and a laser beam having a wavelength λ1 (=650 nm) for an optical disc of DVD standard or a laser beam having a wavelength λ2 (=780 nm) for an optical disc of CD standard is emitted in a selective manner.

The laser beam emitted from the laser light source unit 1 enters a polarizing beam splitter 3 as S-polarized light, for example, through a diffraction grating 2. Further, the S-polarized light is reflected by the polarizing beam splitter 3 and a mirror 4, enters a quarter-wave plate 6 through a collimating lens 5, is converted into circularly polarized light C1 (right circularly polarized light, for example), and then is condensed onto an optical disc 9 by an objective lens 7. Furthermore, the laser beam reflected by the optical disc 9 enters the quarter-wave plate 6 through the objective lens 7 as circularly polarized light C2 (left circularly polarized light, for example) in a direction opposite to that of C1. Then, the circularly polarized light C2 is converted by the quarter-wave plate 6 into P-polarized light orthogonal to the S-polarized light, and then is reflected by the mirror 4, is allowed to pass through the polarizing beam splitter 3, and is incident on a photodetector 8.

In such an optical pickup apparatus, a wide-band quarter-wave plate capable of converting linearly polarized light into circularly polarized light with respect to a laser beam having a wavelength λ1 or λ2 is commonly used as the quarter-wave plate 6. Whereas, when a narrow-band quarter-wave plate is used in order to further reduce the cost of the optical pickup apparatus, it is preferable to use a quarter-wave plate supporting the wavelength λ1 for DVD standard optical disc with higher recording density.

The narrow-band quarter-wave plate is capable of converting the S-polarized light into circularly polarized light C1 with respect to the laser beam having a wavelength in the vicinity of the wavelength λ1 similarly to the wide-band quarter-wave plate 6. Whereas, with respect to the laser beam having the wavelength λ2, the S-polarized light is converted into the elliptically polarized light E1 (right elliptically polarized light, for example), as illustrated in FIG. 6. In this case, the laser beam reflected by the optical disc 9 enters a narrow-band quarter-wave plate 16 through the objective lens 7 as elliptically polarized light E2 (left elliptically polarized light, for example) in a direction opposite to that of E1. Then, the elliptically polarized light E2 is converted into the P-polarized light by the quarter-wave plate 16.

However, in the optical pickup apparatus using the narrow-band quarter-wave plate 16, if variation in birefringence properties of the optical disc is large, some S-polarized components might remain in the P-polarized light converted by the quarter-wave plate 16 as illustrated in FIG. 7, due to the influence of the birefringence properties. In this case, a certain amount of elliptically polarized light in which a certain amount of S-polarized component remains in the P-polarized light (referred to as “P+s” in FIG. 7) enters the polarizing beam splitter 3, and the certain amount of S-polarized component is reflected by the polarizing beam splitter 3 and returns to the laser light source unit 1. Thus, reading and writing performances of the optical pickup apparatus deteriorates due to the influence of the return light to the laser light source unit 1.

### SUMMARY OF THE INVENTION

An optical pickup apparatus according to an aspect of the present invention, includes: a laser light source unit including first and second laser light sources configured to emit laser beams having first and second wavelengths, respectively, the laser light source unit configured to emit the laser beam having the first wavelength or the laser beam having the second wavelength in a selective manner; an objective lens configured to condense the laser beam emitted from the laser light source unit on an optical recording medium; a photodetector configured to detect the laser beam reflected by the optical recording medium; a light splitting unit configured to split the laser beam emitted from the laser light source unit and the laser beam reflected by the optical recording medium in accordance with a wavelength and a polarization direction, and guide the laser beam emitted from the laser light source unit to the objective lens as well as guide the laser beam reflected by the optical recording medium to the photodetector; and a quarter-wave plate arranged between the light splitting unit and the objective lens, the quarter-wave plate configured to convert the laser beam having the first wavelength incident thereon through the light splitting unit from linearly polarized light to circularly polarized light, as well as convert the laser beam having the second wavelength incident thereon through the light splitting unit from linearly polarized light to elliptically polarized light, the laser beam having the second wavelength emitted from the laser light source unit being incident, as first linearly polarized light, on the light splitting unit, and the light splitting unit performing phase shift with respect to the laser beam having the second wavelength incident thereon through the quarter-wave plate so as to reduce a component of the first linearly polarized light.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a block diagram illustrating a configuration of an optical pickup apparatus according to a first embodiment of the present invention;

FIG. 2 is a schematic diagram illustrating an example of intensity of return light returning to a laser light source unit according to a first embodiment of the present invention;

FIG. 3 is a schematic diagram illustrating an example of intensity of incident light incident onto a photodetector according to a first embodiment of the present invention;

FIG. 4 is a block diagram illustrating a configuration of an optical pickup apparatus according to a second embodiment of the present invention;

FIG. 5 is a diagram for explaining an operation of an optical pickup apparatus supporting two wavelength laser beams using a wide-band quarter-wave plate;

FIG. 6 is a diagram for explaining an operation of an optical pickup apparatus supporting two wavelength laser beams using a narrow-band quarter-wave plate; and

FIG. 7 is a diagram for explaining an operation of an optical pickup apparatus supporting two wavelength laser beams using a narrow-band quarter-wave plate when variation in birefringence properties of an optical disc is large.

### DETAILED DESCRIPTION OF THE INVENTION

At least the following details will become apparent from descriptions of this specification and of the accompanying drawings.

### First Embodiment

### Configuration of Optical Pickup Apparatus

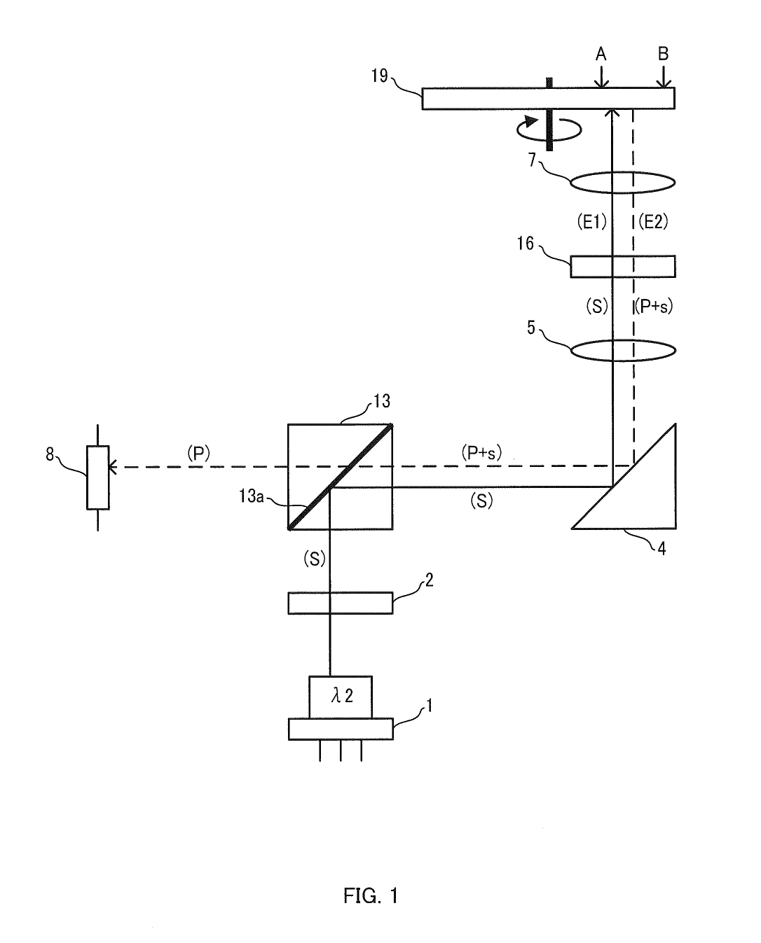

A configuration of an optical pickup apparatus according to a first embodiment of the present invention will be described hereinafter by referring to FIG. 1.

The optical pickup apparatus illustrated in FIG. 1 includes a laser light source unit 1, a diffraction grating 2, a polarizing beam splitter 13 (polarizing member), a mirror 4, a collimating lens 5, a quarter-wave plate 16, an objective lens 7, and a photodetector 8. Further, the optical pickup apparatus is capable of reading/writing signals in a plurality of optical discs of different standards such as DVD standard and CD standard. FIG. 1 illustrates a case where an optical disc 19 of CD standard is set to be read.

In an embodiment of the present invention, the polarizing beam splitter 13 and the mirror 4 are equivalent to a light splitting unit. Further, a narrow-band quarter-wave plate supporting a wavelength λ1 (first wavelength) for an optical disc of DVD standard is used as the quarter-wave plate 16. Thus, the quarter-wave plate 16 converts linearly polarized light into circularly polarized light, with respect to the laser beam having a wavelength in the vicinity of the wavelength λ1, while the quarter-wave plate 16 converts the linearly polarized light into elliptically polarized light, with respect to the laser beam having a wavelength λ2 (second wavelength) for an optical disc of CD standard.

The laser light source unit 1 includes (first and second) laser light sources configured to emit laser beams having the wavelengths λ1 and λ2, respectively, and the laser light source unit 1 is configured to emit the laser beam having the wavelength λ1 or λ2 in a selective manner in accordance with the set optical disc.

Similarly to FIG. 9 in Patent Literature 2, for example, hereinafter, a description will be given of a case where a two-wavelength multi-laser light source, in which a laser light source for the laser beam having the wavelength λ1 and a laser light source for the laser beam having the wavelength λ2 are provided in the same package, is used as the laser light source unit 1. However, similarly to FIG. 1 of Patent Literature 1, for example, the laser light source unit 1 may be configured with separate laser light sources that emit laser beams having wavelengths, respectively, and diffraction gratings and polarizing beam splitters may be provided corresponding to laser beams, respectively. In this case, FIG. 1 illustrates the diffraction grating 2 and the polarizing beam splitter 13 corresponding to the laser beam having the wavelength λ2 but does not illustrate a diffraction grating or a polarizing beam splitter corresponding to the laser beam having the wavelength λ1.

In FIG. 1, a solid line arrow indicates an optical path (outward path) leading a laser beam emitted from the laser light source unit 1 to be condensed onto the optical disc 19, while a broken line arrow indicates an optical path (return path) leading the laser beam reflected by the optical disc 19 to be incident onto the photodetector 8.

On the outward path, the diffraction grating 2 and the polarizing beam splitter 13 are arranged such that the laser beam emitted from the laser light source unit 1 is incident on the polarizing beam splitter 13 through the diffraction grating 2. Further, the polarizing beam splitter 13 and the mirror 4 are arranged such that the laser beam reflected by the polarizing beam splitter 13 is incident on the mirror 4. The mirror 4, the collimating lens 5, the quarter-wave plate 16, and the objective lens 7 are arranged such that the laser beam reflected by the mirror 4 is condensed onto the optical disc 19 through the collimating lens 5, the quarter-wave plate 16, and the objective lens 7.

On the other hand, on the return path, the laser beam reflected by the optical disc 19 is incident on the mirror 4 again through the objective lens 7, the quarter-wave plate 16, and the collimating lens 5. The mirror 4, the polarizing beam splitter 13, and the photodetector 8 are arranged such that the laser beam reflected by the mirror 4 is incident on the polarizing beam splitter 13 and the laser beam having passed through the polarizing beam splitter 13 is further incident on the photodetector 8.

### Operation of Optical Pickup Apparatus

Subsequently, an operation of the optical pickup apparatus according to an embodiment of the present invention will be described.

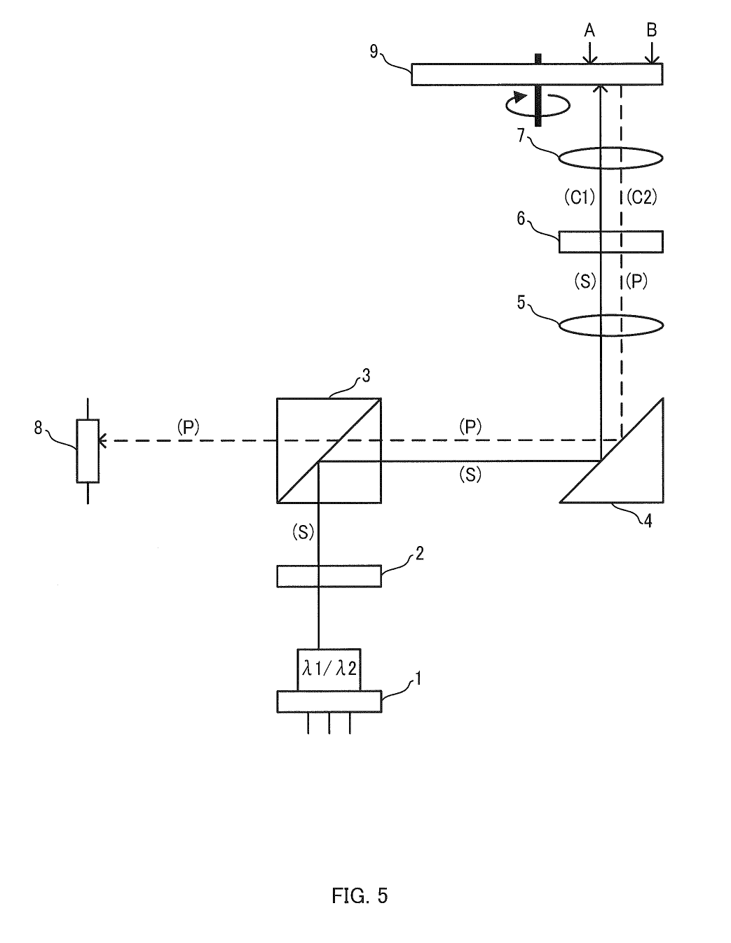

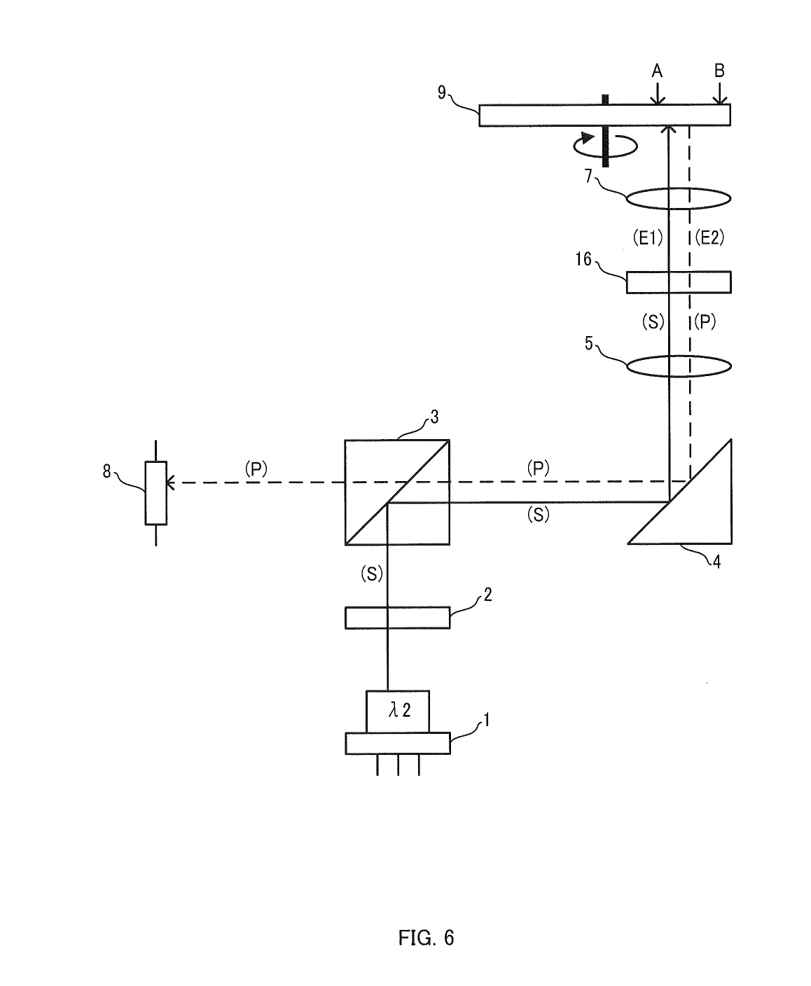

As described above, in an embodiment of the present invention, the narrow-band quarter-wave plate supporting the wavelength λ1 is used as the quarter-wave plate 16. Thus, the operation of the optical pickup apparatus according to an embodiment of the present invention for the DVD standard optical disc is similar to the operation of the optical pickup apparatus using the wide-band quarter-wave plate illustrated in FIG. 5. Further, the operation of the optical pickup apparatus according to an embodiment of the present invention for the CD standard optical disc having birefringence properties with sufficiently small variation is similar to the operation of the optical pickup apparatus using the narrow-band quarter-wave plate illustrated in FIG. 6. Thus, hereinafter, the operation for the CD standard optical disc 19 having birefringence properties with large variation will be described.

If the CD standard optical disc 19 is set to be read, the laser light source unit 1 selects and emits the laser beam having the wavelength λ2. Further, the laser beam emitted from the laser light source unit 1 is split by the diffraction grating 2 into main-beam (zero-order light) and sub-beams (plus/minus first-order diffracted light beams, for example), and then enters the polarizing beam splitter 13 as the S-polarized light (first linearly polarized light), for example.

The polarizing beam splitter 13 reflects a major part (substantially 90 to 100%, for example) of the S-polarized component contained in the laser beam having the wavelength λ2, and allows a part (substantially 20 to 30%, for example) of the component of the P-polarized light (second linearly polarized light) contained therein. Thus, the polarizing beam splitter 13 reflects a major part of the laser beam incident thereon through the diffraction grating 2, and the reflected laser beam is incident on the mirror 4 and is further reflected thereby.

The laser beam reflected by the mirror 4 is converted by the collimating lens 5 into parallel light, and then enters the quarter-wave plate 16. Further, the quarter-wave plate 16 converts the laser beam incident thereon through the collimating lens 5 from the S-polarized light to elliptically polarized light E1 (right elliptically polarized light, for example), and the objective lens 7 condenses the elliptically polarized light E1 onto the optical disc 19.

Whereas, the laser beam reflected by the optical disc 19 enters the quarter-wave plate 16 through the objective lens 7 as the elliptically polarized light E2 in a direction opposite to that of E1 (left elliptically polarized light, for example). Further, the quarter-wave plate 16 converts the incident laser beam from the elliptically polarized light E2 into the P-polarized light. However, a certain amount of S-polarized component actually remains in the P-polarized light due to the influence of birefringence properties of the optical disc 19, which results in a certain amount of elliptically polarized light P+s. Then, the certain amount of elliptically polarized light P+s is incident on the mirror 4 through the collimating lens 5, and is further reflected thereby.

The laser beam reflected by the mirror 4 enters the polarizing beam splitter 13. Further, since the polarizing beam splitter 13 is provided with a special polarizing film 13a, for example, a part of the P-polarized component is allowed to pass therethrough while the S-polarized component is phase shifted by substantially 90° (90°±15° or preferably substantially) 90°±5° with respect to the incident laser beam having the wavelength λ2. The special film such as the polarizing film 13a is formed on a desired surface of the polarizing beam splitter 13 by a vacuum deposition method, a sputtering method and the like, for example. The polarizing film 13a is structured as a thin layer containing at least one or more types of substances selected from a group consisting of SiO2, ZnO2, Ta2O5, TiO2 and Ti2O5, for example. As such, since the special polarizing film 13a, for example, is provided in the polarizing beam splitter 13, a part of the P-polarized component is allowed to pass therethrough while the S-polarized component is phase shifted by substantially 90° with respect to the incident laser beam having the wavelength λ2. Thus, the polarizing beam splitter 13 reduces the S-polarized component in a certain amount of elliptically polarized light P+s, resulting in substantially linearly polarized light (substantially P-polarized light).

Therefore, the proportion of the laser beam, having passed through the polarizing beam splitter 13 and incident on the photodetector 8, to the laser beam having the wavelength λ2 on the return path increases, and the proportion of the laser beam reflected by the polarizing beam splitter 13 and returning to the laser light source unit 1 decreases. Then, the photodetector 8 detects the incident laser beam having passed through the polarizing beam splitter 13. On the outward path, since the laser beam having the wavelength λ2 incident on the polarizing beam splitter 13 does not include the P-polarized component, the laser beam reflected by the polarizing beam splitter 13 remains as the S-polarized light.

As such, the optical pickup apparatus according to an embodiment of the present invention phase shifts the a certain amount of S-polarized component by substantially 90° by means of the polarizing beam splitter 13, with respect to the laser beam having the wavelength λ2 on the return path, and reduces the return light returning to the laser light source unit 1.

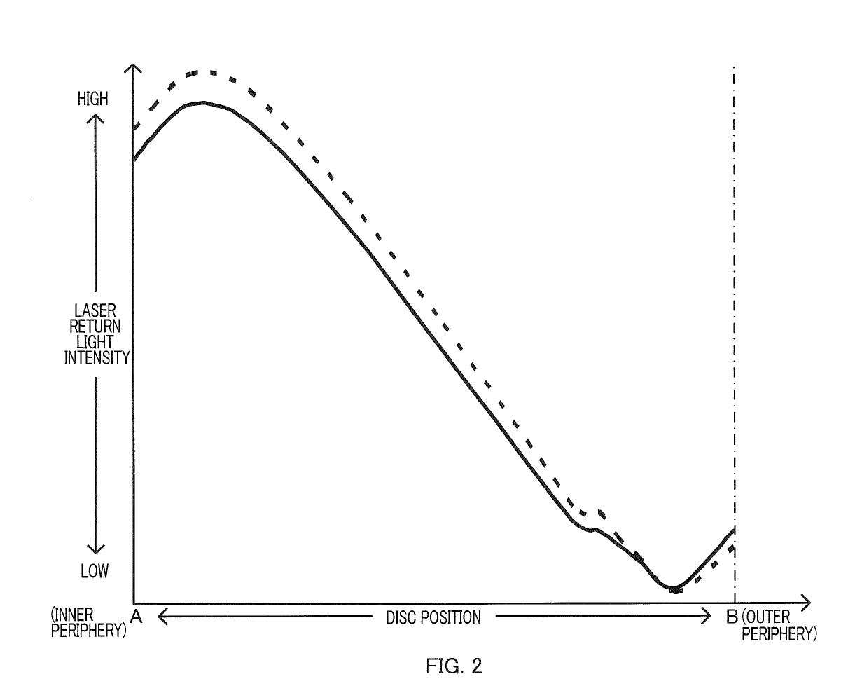

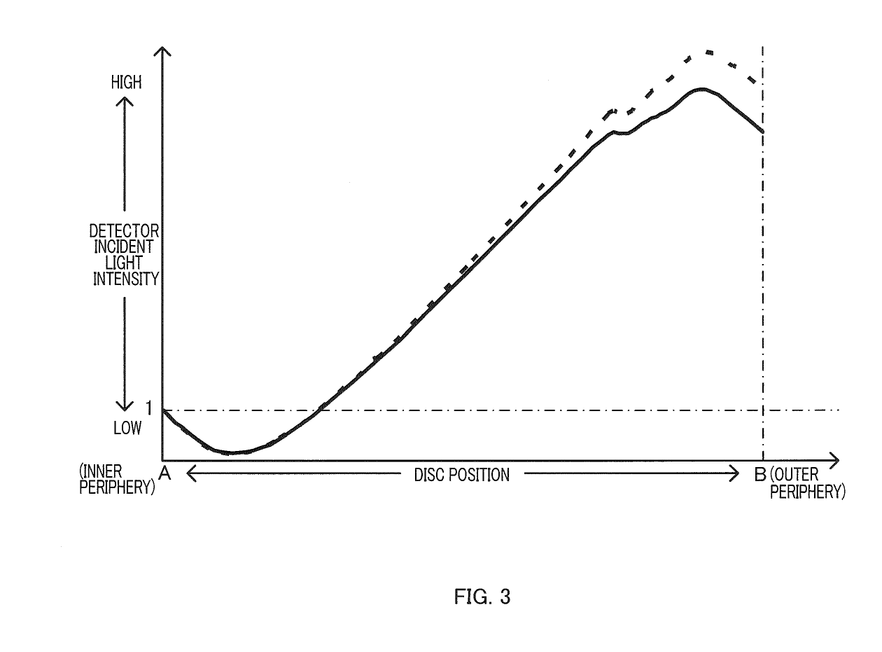

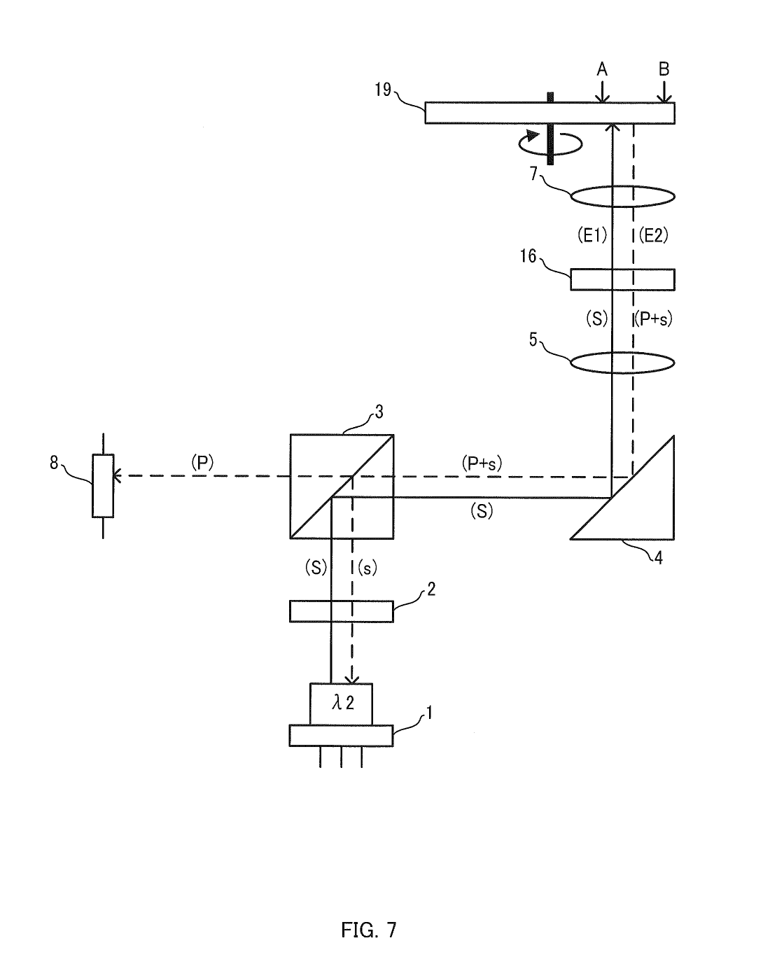

The intensity of the return light returning to the laser light source unit 1 and the intensity of the incident light incident on the photodetector 8 in accordance with the radial direction of the optical disc 19 are illustrated in FIGS. 2 and 3, respectively, as an example. As is evident from FIG. 2, the maximum value of the intensity of the return light returning to the laser light source unit 1 in the optical pickup apparatus according to an embodiment of the present invention indicated by a solid line is smaller than that in the case of the optical pickup apparatus in FIG. 7 indicated by a broken line. Further, as is evident from FIG. 3, the range of variation in the intensity of the incident light incident on the photodetector 8 in the optical pickup apparatus according to an embodiment of the present invention indicated by a solid line is smaller than that in the case of the optical pickup apparatus in FIG. 7 indicated by a broken line.

### Second Embodiment

### Configuration and Operation of Optical Pickup Apparatus

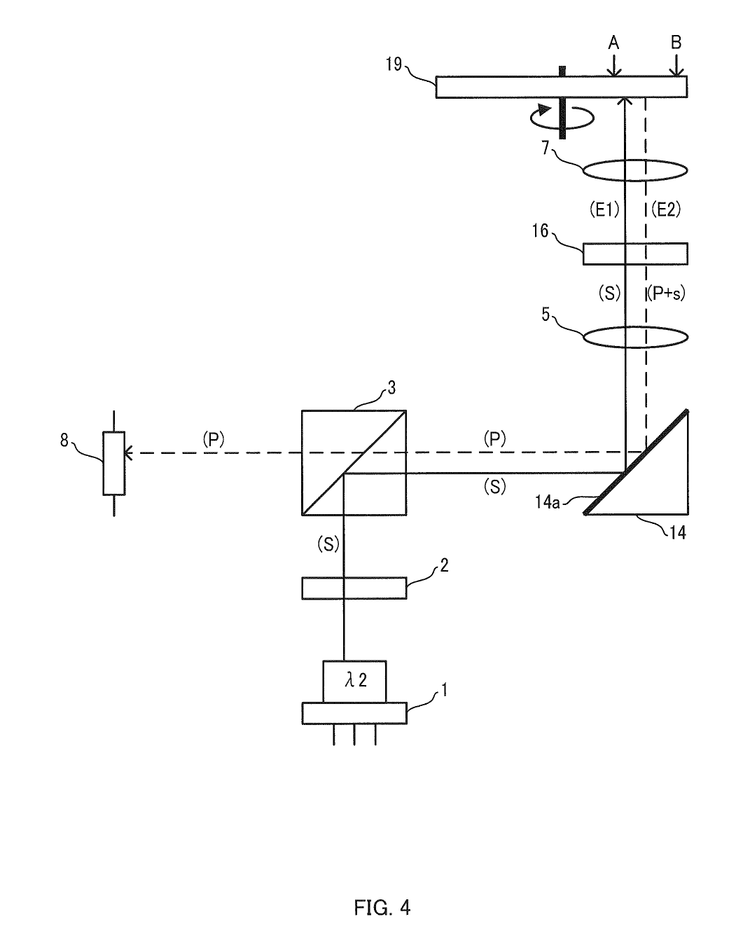

A configuration of an optical pickup apparatus according to a second embodiment of the present invention will be described hereinafter by referring to FIG. 4. The optical pickup apparatus illustrated in FIG. 4 includes the polarizing beam splitter 3 in place of the polarizing beam splitter 13 and includes a mirror 14 in place of the mirror 4, as compared with the optical pickup apparatus according to a first embodiment of the present invention.

Subsequently, an operation of the optical pickup apparatus according to an embodiment of the present invention will be described. Similarly to a first embodiment of the present invention, the operation of the optical pickup apparatus according to an embodiment of the present invention for a DVD standard optical disc is similar to the operation of the optical pickup apparatus using the wide-band quarter-wave plate illustrated in FIG. 5. Further, the operation of the optical pickup apparatus according to an embodiment of the present invention for a CD standard optical disc having birefringence properties with sufficiently small variation is similar to the operation of the optical pickup apparatus using the narrow-band quarter-wave plate illustrated in FIG. 6. Thus, the operation for the CD standard optical disc 19 having birefringence properties with large variation will hereinafter be described.

When the CD standard optical disc 19 is set to be read, the laser light source unit 1 selects and emits the laser beam having the wavelength λ2. Further, the laser beam emitted from the laser light source unit 1 is split by the diffraction grating 2 into a main-beam and sub-beams, and then enters the polarizing beam splitter 3 as the S-polarized light, for example.

The polarizing beam splitter 3 reflects a major part of the S-polarized component contained in the laser beam having the wavelength λ2 and allows a part of the P-polarized component contained therein to pass therethrough. Thus, the polarizing beam splitter 3 reflects a major part of the laser beam incident thereon through the diffraction grating 2, and the reflected laser beam is incident on the mirror 14 and is further reflected thereby.

The laser beam reflected by the mirror 14 is converted by the collimating lens 5 into parallel light, and enters the quarter-wave plate 16. Further, the quarter-wave plate 16 converts the laser beam incident thereon through the collimating lens 5 from the S-polarized light to the elliptically polarized light E1, and the objective lens 7 condenses the elliptically polarized light E1 onto the optical disc 19.

Whereas, the laser beam reflected by the optical disc 19 enters the quarter-wave plate 16 through the objective lens 7 as the elliptically polarized light E2. Further, the quarter-wave plate 16 converts the incident laser beam from the elliptically polarized light E2 into the P-polarized light. However, a certain amount of S-polarized component actually remains in the P-polarized light due to the influence of birefringence properties of the optical disc 19, resulting in a certain amount of elliptically polarized light P+s. Then, the certain amount of elliptically polarized light P+s is incident on the mirror 14 through the collimating lens 5.

Since the mirror 14 is provided with a special polarizing film 14a, for example, the mirror 14 reflects the laser beam having the wavelength λ2 incident thereon through the collimating lens 5 after phase shifting the S-polarized component by substantially 90°. The special film such as the polarizing film 14a is formed on a desired surface of the mirror 14 by a vacuum deposition method, a sputtering method and the like, for example. The polarizing film 14a is structured as a thin layer containing at least one or more types of substances selected from a group consisting of SiO2, ZnO2, Ta2O5, TiO2 and Ti2O5, for example. As such, since the special polarizing film 14a, for example, is provided on the mirror 14, the laser beam is reflected in a state where the S-polarized component is phase shifted by substantially 90° (90°±15° or preferably substantially 90°±5°) with respect to the incident laser beam having the wavelength λ2. Thus, the mirror 14 reduces the S-polarized component in a certain amount of elliptically polarized light P+s, which results in substantially linearly polarized light (substantially P-polarized light). Further, the laser beam reflected by the mirror 14 enters the polarizing beam splitter 3. Furthermore, the polarizing beam splitter 3 allows a part of the P-polarized component in the incident laser beam having the wavelength λ2 to pass therethrough.

Therefore, the proportion of the laser beam, having passed through the polarizing beam splitter 3 and incident on the photodetector 8, to the laser beam having the wavelength λ2 on the return path increases, and the proportion of the laser beam reflected by the polarizing beam splitter 3 and returning to the laser light source unit 1 decreases. Then, the photodetector 8 detects the incident laser beam having passed through the polarizing beam splitter 3. On the outward path, since the laser beam having the wavelength λ2 incident on the mirror 14 does not include the P-polarized component, the laser beam reflected by the mirror 14 remains as the S-polarized light.

As such, the optical pickup apparatus according to an embodiment of the present invention phase shifts a certain amount of S-polarized component by substantially 90° by means of the mirror 14, with respect to the laser beam having the wavelength λ2 on the return path, thereby reducing the return light returning to the laser light source unit 1.

As described above, in the optical pickup apparatuses according to first and second embodiments of the present invention, the quarter-wave plate 16 is arranged between the light splitting unit including the polarizing beam splitter and the mirror and the objective lens 7, and conversion between the linearly polarized light and the elliptically polarized light is carried out on the side closer to the objective lens 7 than the light splitting unit. Thus, the phase shift of the laser beam having the wavelength λ2 on the return path may be performed by either of the polarizing beam splitter or the mirror. Further, a configuration may be such that the polarizing beam splitter and the mirror perform phase shifts, respectively, so as to phase shift a certain amount of S-polarized component by substantially 90° in total.

As described above, in the optical pickup apparatus illustrated in FIGS. 1 and 4 capable of supporting optical discs of DVD standard and CD standard, the narrow-band quarter-wave plate 16 supporting the wavelength λ1 is arranged between the objective lens 7 and the light splitting unit that is configured to guide, to the objective lens 7, the laser beam having the wavelength λ1 or λ2 emitted from the laser light source unit 1 in a selective manner and guide, to the photodetector 8, the laser beam reflected by the optical disc, and the laser beam having the wavelength λ2 on the return path is phase shifted in the light splitting unit so as to reduce the S-polarized component, thereby being able to reduce the return light returning to the laser light source unit 1 when the narrow-band quarter-wave plate 16 is used.

Further, the S-polarized component is phase shifted with respect to the laser beam having the wavelength λ2 on the return path, so that the phase difference between the P-polarized component and the S-polarized component results in substantially 90°, thereby being able to reduce the S-polarized component in a certain amount of elliptically polarized light P+s, which results in substantially P-polarized light.

Further, in the optical pickup apparatus illustrated in FIG. 1, the laser beam having the wavelength λ2 on the return path is phase shifted by substantially 90° by means of the polarizing beam splitter 13, thereby being able to reduce the S-polarized component solely using the polarizing beam splitter 13.

Further, in the optical pickup apparatus illustrated in FIG. 4, the laser beam having the wavelength λ2 on the return path is phase shifted by substantially 90° by means of the mirror 14, thereby being able to reduce the S-polarized component solely using the mirror 14.

Further, the polarizing beam splitter and the mirror perform phase shifts, respectively, so that the S-polarized component is phase shifted by substantially 90° in total, thereby being able to flexibly design a wave plate that is configured to adjust the phase difference between the P-polarized component and the S-polarized component.

The above embodiments of the present invention are simply for facilitating the understanding of the present invention and are not in any way to be construed as limiting the present invention. The present invention may variously be changed or altered without departing from its spirit and encompass equivalents thereof.

In embodiments of the present invention described above, the optical pickup apparatus supports optical discs of DVD standard and CD standard, and the laser light source unit 1 includes laser light sources for the standards, respectively, but it is not limited thereto. The optical pickup apparatus may further support an optical disc of the BD (Blu-ray Disc) (registered trademark) standard using a blue-violet laser beam having a wavelength of 405 nm band, for example, and the laser light source unit 1 may further include a laser light source for an optical disc of BD standard. Further, mirrors such as a semitransparent mirror (half mirror) configured to reflect a part of the laser beam and allow a part of the laser beam to pass therethrough and/or a reflect mirror and the like may be included as the light splitting unit on the optical path of the optical pickup apparatus, in addition to the polarizing beam splitter 13 and/or the mirror 14. Furthermore, mirrors such as a semitransparent mirror configured to reflect a part of the laser beam and allow apart of the laser beam to pass therethrough and/or a reflect mirror and the like may be used as the light splitting unit, in place of the polarizing beam splitter 13 and/or the mirror 14. Furthermore, the polarizing beam splitter 13 and/or the mirror 14 and mirrors such as a semitransparent mirror and/or a reflect mirror and the like may be used as the light splitting unit.

What is claimed is:

1. An optical pickup apparatus comprising:
a laser light source unit including first and second laser light sources configured to emit laser beams having first and second wavelengths, respectively, the laser light source unit configured to emit the laser beam having the first wavelength or the laser beam having the second wavelength in a selective manner;
an objective lens configured to condense the laser beam emitted from the laser light source unit on an optical recording medium;
a photodetector configured to detect the laser beam reflected by the optical recording medium;
a light splitting unit configured to split the laser beam emitted from the laser light source unit and the laser beam reflected by the optical recording medium in accordance with a wavelength and a polarization direction, and guide the laser beam emitted from the laser light source unit to the objective lens as well as guide the laser beam reflected by the optical recording medium to the photodetector; and
a quarter-wave plate arranged between the light splitting unit and the objective lens, the quarter-wave plate configured to convert the laser beam having the first wavelength incident thereon through the light splitting unit from linearly polarized light to circularly polarized light, as well as convert the laser beam having the second wavelength incident thereon through the light splitting unit from linearly polarized light to elliptically polarized light,
the laser beam having the second wavelength emitted from the laser light source unit being incident, as first linearly polarized light, on the light splitting unit, and the light splitting unit performing phase shift with respect to the laser beam having the second wavelength incident thereon through the quarter-wave plate so as to reduce a component of the first linearly polarized light.

2. The optical pickup apparatus according to claim 1, wherein
the light splitting unit is further configured to phase shift, by substantially 90°, a component of the first linearly polarized light with respect to the laser beam having the second wavelength incident thereon through the quarter-wave plate.

3. The optical pickup apparatus according to claim 1, wherein
the light splitting unit includes a polarizing member configured to reflect a major part of a component of the first linearly polarized light contained in the laser beam having the second wavelength, as well as allow a part of a component of a second linearly polarized light orthogonal to the first linearly polarized light to pass therethrough, and the light splitting unit is configured to guide, to the objective lens, the laser beam having the second wavelength emitted from the laser light source unit and reflected by the polarizing member, as well as guide, to the photodetector, the laser beam having the second wavelength reflected by the optical recording medium and having passed through the polarizing member, and
the polarizing member is further configured to perform phase shift with respect to the laser beam having the second wavelength incident thereon through the quarter-wave plate so as to reduce a component of the first linearly polarized light.

4. The optical pickup apparatus according to claim 1, wherein
the light splitting unit includes a mirror configured to reflect the laser beam having the second wavelength incident thereon through the quarter-wave plate, and
the mirror is configured to perform phase shift with respect to the laser beam having the second wavelength incident thereon through the quarter-wave plate so as to reduce a component of the first linearly polarized light.

5. The optical pickup apparatus according to claim 1, wherein
the light splitting unit includes:
a polarizing member configured to reflect a major part of a component of the first linearly polarized light contained in the laser beam having the second wavelength as well as allow a part of a component of a second linearly polarized light orthogonal to the first linearly polarized light to pass therethrough; and
a mirror configured to reflect the laser beam having the second wavelength reflected by the polarizing member and guide the reflected laser beam to the objective lens, as well as reflect the laser beam having the second wavelength incident thereon through the quarter-wave plate and guide the reflected laser beam to the polarizing member, and
the polarizing member and the mirror is further configured to phase shift, by substantially 90° in total, a component of the first linearly polarized light with respect to the laser beam having the second wavelength incident thereon through the quarter-wave plate.
